(19) United States
(12) Patent Application Publication
(10) Pub. No.: US 2010/0091739 A1
(43) Pub. Date: Apr. 15, 2010

(54) METHODS AND SYSTEMS FOR PRE-ALLOCATING A CQI CHANNEL DURING HANDOFF

(75) Inventors: Pranav Dayal, San Diego, CA (US); Mahesh Makhijani, San Diego, CA (US)

Correspondence Address: QUALCOMM INCORPORATED, 5775 MOREHOUSE DR., SAN DIEGO, CA, 92121, US

(73) Assignee: QUALCOMM INCORPORATED, San Diego, CA (US)

(21) Appl. No.: 12/560,933

(22) Filed: Sep. 16, 2009

Related U.S. Application Data
(60) Provisional application No. 61/105,319, filed on Oct. 14, 2008.

(51) Int. Cl. H04W 4/00; H04W 36/00; H04W 72/00

(52) U.S. Cl. 370/332; 455/439; 370/338; 455/450

(57) ABSTRACT

Methods and systems for improving handover performance by pre-negotiating channel quality information between a serving base station and a target base before a handoff is initiated in a wireless communication system are described. The target base station may send to the serving base station an assigned location within an uplink subframe for a mobile station requesting a handover to the target base station to transmit channel quality information to the target base station. The serving base station may send this information to the mobile station. The mobile station may transmit channel quality information to the target base station at the assigned location.

### CLAIM OF PRIORITY UNDER 35 U.S.C. §119

This application claims the benefit of priority from U.S. Provisional Patent Application Ser. No. 61/105,319, entitled “Methods and Systems for Pre-Allocating a CQI Channel for Base Station Handoff” and filed Oct. 14, 2008, which is assigned to the assignee of this application and is fully incorporated by reference herein for all purposes.

### TECHNICAL FIELD

The present disclosure generally relates to wireless communication, and more specifically to methods and systems for improving handover performance by pre-negotiating channel quality information between a serving base station and a target base station before a mobile station hands over from the serving base station to the target base station.

### SUMMARY

Certain embodiments provide a method for wireless communication. The method generally includes sending a handover request to a serving base station for handover to a target base station, receiving a response to the handover request, the response including an indication of an assigned location within an uplink sub-frame for transmitting channel quality information (CQI) to the target base station, and transmitting CQI to the target base station at the assigned location.

Certain embodiments provide a method for wireless communication by a target base station. The method generally includes sending, to a serving base station, an assigned location within an uplink sub-frame for a mobile station requesting a handover to the target base station to transmit channel quality information (CQI) to the target base station, receiving CQI from the mobile station at the assigned location, and transmitting data to the mobile station in accordance with a modulation and coding scheme (MCS) selected based on the CQI.

Certain embodiments provide a method for wireless communication by a serving base station. The method generally includes receiving, from a target base station, an assigned location within an uplink sub-frame for a mobile station requesting a handover to the target base station to transmit channel quality information (CQI) to the target base station, sending the assigned location to the mobile station, receiving a handover indication that the mobile station is to handover to the target base station, and releasing the mobile station.

Certain embodiments provide an apparatus for wireless communication. The apparatus generally includes logic for sending a handover request to a serving base station for handover to a target base station, logic for receiving a response to the handover request, the response including an indication of an assigned location within an uplink sub-frame for transmitting channel quality information (CQI) to the target base station, and logic for transmitting CQI to the target base station at the assigned location.

Certain embodiments provide an apparatus for wireless communication by a target base station. The apparatus generally includes logic for sending, to a serving base station, an assigned location within an uplink sub-frame for a mobile station requesting a handover to the target base station to transmit channel quality information (CQI) to the target base station, logic for receiving CQI from the mobile station at the assigned location, and logic for transmitting data to the mobile station in accordance with a modulation and coding scheme (MCS) selected based on the CQI.

Certain embodiments provide an apparatus for wireless communication by a serving base station. The apparatus generally includes logic for receiving, from a target base station, an assigned location within an uplink sub-frame for a mobile station requesting a handover to the target base station to transmit channel quality information (CQI) to the target base station, logic for sending the assigned location to the mobile station, logic for receiving a handover indication that the mobile station is to handover to the target base station, and logic for releasing the mobile station.

Certain embodiments provide an apparatus for wireless communication. The apparatus generally includes means for sending a handover request to a serving base station for handover to a target base station, means for receiving a response to the handover request, the response including an indication of an assigned location within an uplink sub-frame for transmitting channel quality information (CQI) to the target base station, and means for transmitting CQI to the target base station at the assigned location.

Certain embodiments provide an apparatus for wireless communication by a target base station. The apparatus generally includes means for sending, to a serving base station, an assigned location within an uplink sub-frame for a mobile station requesting a handover to the target base station to transmit channel quality information (CQI) to the target base station, means for receiving CQI from the mobile station at the assigned location, and means for transmitting data to the mobile station in accordance with a modulation and coding scheme (MCS) selected based on the CQI.

Certain embodiments provide an apparatus for wireless communication by a serving base station. The apparatus generally includes means for receiving, from a target base station, an assigned location within an uplink sub-frame for a mobile station requesting a handover to the target base station to transmit channel quality information (CQI) to the target base station, means for sending the assigned location to the mobile station, means for receiving a handover indication that the mobile station is to handover to the target base station, and means for releasing the mobile station.

Certain embodiments of the present disclosure provide a computer-program product for wireless communications, comprising a computer readable medium having instructions stored thereon, the instructions being executable by one or more processors. The instructions generally include instructions for instructions for sending a handover request to a serving base station for handover to a target base station, instructions for receiving a response to the handover request, the response including an indication of an assigned location within an uplink sub-frame for transmitting channel quality information (CQI) to the target base station, and instructions for transmitting CQI to the target base station at the assigned location.

Certain embodiments of the present disclosure provide a computer-program product for wireless communications by a target base station, comprising a computer readable medium having instructions stored thereon, the instructions being executable by one or more processors. The instructions generally include instructions for instructions for sending, to a serving base station, an assigned location within an uplink sub-frame for a mobile station requesting a handover to the target base station to transmit channel quality information (CQI) to the target base station, instructions for receiving CQI from the mobile station at the assigned location, and instructions for transmitting data to the mobile station in accordance with a modulation and coding scheme (MCS) selected based on the CQI.

Certain embodiments of the present disclosure provide a computer-program product for wireless communications by a serving base station, comprising a computer readable medium having instructions stored thereon, the instructions being executable by one or more processors. The instructions generally include instructions for instructions for receiving, from a target base station, an assigned location within an uplink sub-frame for a mobile station requesting a handover to the target base station to transmit channel quality information (CQI) to the target base station, instructions for sending the assigned location to the mobile station, instructions for receiving a handover indication that the mobile station is to handover to the target base station, and instructions for releasing the mobile station.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects.

FIG. 1 illustrates an exemplary wireless communication system in accordance with certain embodiments set forth herein.

FIG. 2 illustrates an exemplary wireless network environment in accordance with certain embodiments set forth herein.

FIG. 3 illustrates a handover procedure in accordance with certain embodiments of the present disclosure.

FIG. 4 illustrates example operations that may be performed by a mobile station for an improved handover technique, in accordance with certain embodiments of the present disclosure.

FIG. 4A illustrates example components capable of performing the operations illustrated in FIG. 4.

FIG. 5 illustrates example operations that may be performed by a serving base station for an improved handover technique by pre-negotiating channel quality information between a serving base station and a target base station, in accordance with certain embodiments of the present disclosure.

FIG. 5A illustrates example components capable of performing the operations illustrated in FIG. 5.

FIG. 6 illustrates example operations that may be performed by a target base station for an improved handover technique by pre-negotiating channel quality information between a serving base station and a target base station, in accordance with certain embodiments of the present disclosure.

FIG. 6A illustrates example components capable of performing the operations illustrated in FIG. 6.

### DETAILED DESCRIPTION

Certain embodiments are described herein with reference to the drawings, wherein like reference numerals are used to refer to like elements throughout. In the following description, for purposes of explanation, numerous specific details are set forth in order to provide a thorough understanding of certain embodiments. However, it may be that such embodiment(s) can be practiced without these specific details. In other instances, well-known structures and devices are shown in block diagram form in order to facilitate describing certain embodiments.

The word “exemplary” is used herein to mean “serving as an example, instance, or illustration.” Any method, apparatus, feature, device, aspect, embodiment or design described herein as “exemplary” is not necessarily meant to be construed as preferred or as exclusive or preclusive of any other method, apparatus, feature, device, aspect, embodiment or design also described herein.

Worldwide Interoperability for Microwave Access (WiMAX) standard mandates hard handover procedure, which is also specified by the Institute of Electrical and Electronic Engineers (IEEE) 802.16 standard. Seamless handover is one of the hard handover procedures specified in the IEEE 802.16 standard. In the seamless handover, the target base station (BS) and serving BS pre-negotiate new Connection Identifiers (CIDs) to be used at the target BS once the mobile station (MS) begins to be served by the target BS. Because the CIDs are pre-allocated, it is possible for the target BS to address downlink (DL) and uplink (UL) allocations to the MS from a pre-determined time. The MS stores all the data received from the target BS until the Ranging Request/Response handshake is completed. Subsequently, the MS starts to forward data to upper layers if the MS can verify the authenticity of the data.

There are at least two concerns with the seamless handover mechanism. First, the target base station may not know the modulation and coding scheme (MCS) to use to send the data to the mobile station or to assign uplink allocations to the mobile station. Second, it is not clear how often the target base station should keep sending the new assignment messages before the Ranging Request/Response handshake is completed, thereby leading to unnecessary overhead.

Certain disclosed embodiments may be used in various wireless communication networks or mobile communications systems such as wireless wide area networks (WWANs), wireless metropolitan area networks (WMANs), wireless local area networks (WLANs), ultra mobile broadband (UMB), universal mobile telecommunications system (UMTS), UMTS long term evolution (LTE), and so on. The terms “network” and “system” are often used interchangeably. The techniques may also be used for various multiple access networks such as Frequency Division Multiple Access (FDMA), Code Division Multiple Access (CDMA), Wideband-CDMA, Time Division Multiple Access (TDMA), Spatial Division Multiple Access (SDMA), Orthogonal FDMA (OFDMA), Single-Carrier FDMA (SC-FDMA), and other such networks. An OFDMA network utilizes Orthogonal Frequency Division Multiplexing (OFDM).

Certain disclosed embodiments may also be used with various antenna arrangements such as single-input single-output (SISO), single-input multiple-output (SIMO), multiple-input single-output (MISO), and multiple-input multiple-output (MIMO) transmissions. Single-input refers to one transmit antenna and multiple-input refers to multiple transmit antennas for data transmission. Single-output refers to one receive antenna and multiple-output refers to multiple receive antennas for data reception.

The rapid growth in wireless internets and communications has led to an increasing demand for high data rate in the field of wireless communications services. OFDM/OFDMA systems are regarded as a promising research area and a possible technology for next generation wireless communications. This is because OFDM/OFDMA modulation schemes can provide many advantages like modulation efficiency, spectrum efficiency, flexibility, and strong multi-path immunity with a relatively simple equalizer over some single carrier modulation schemes.

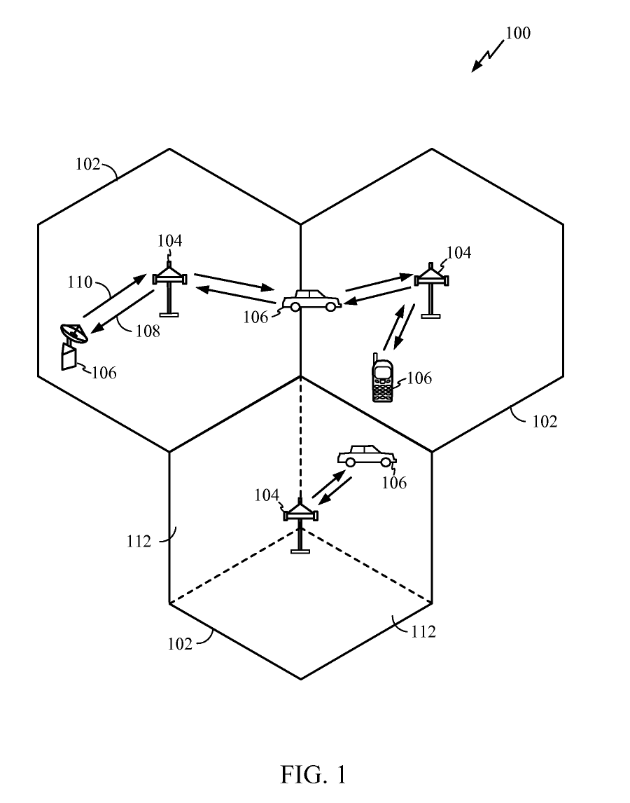

FIG. 1 illustrates an exemplary wireless communication system 100 in accordance with certain embodiments set forth herein. The system 100 may be a broadband wireless communication system. The term “broadband wireless” refers to technology that at least provides wireless, audio, video, voice, Internet, and/or data network access. The system 100 provides communication for one or more cells 102, each of which is serviced by a base station 104. Base station 104 may be a fixed station that communicates with user terminals 106 within cell 102 serviced by that base station 104. Base station 104 may alternatively be referred to as an access point, Node B or some other terminology.

As shown in FIG. 1, various user terminals 106 dispersed throughout the system 100. User terminals 106 may be fixed (i.e., stationary), mobile or capable of both. User terminals 106 may alternatively be referred to as remote stations, access terminals, terminals, subscriber units, mobile stations, stations, user equipment and the like. User terminals 106 may be personal wireless devices, such as cellular phones, personal digital assistants (PDAs), handheld devices, wireless modems, audio/video players, laptop computers, personal computers, other handheld communication devices, other handheld computing devices, satellite radios, global positioning systems, and so on. A variety of algorithms and methods may be used for transmissions in the system 100 between base stations 104 and user terminals 106. For example, signals may be sent and received between base stations 104 and user terminals 106 in accordance with OFDM/OFDMA techniques. If this is the case, the system 100 may be referred to as an OFDM/OFDMA system.

A communication link that facilitates transmission from base station 104 to user terminal 106 may be referred to as a downlink 108, and a communication link that facilitates transmission from user terminal 106 to base station 104 may be referred to as an uplink 110. Alternatively, downlink 108 may be referred to as a forward link or a forward channel, and uplink 110 may be referred to as a reverse link or a reverse channel. Cell 102 may be divided into multiple sectors 112. Sector 112 is a physical coverage area within cell 102. Base stations 104 within an OFDM/OFDMA system may utilize antennas that concentrate the flow of power within a particular sector 112 of the cell 102. Such antennas may be referred to as directional antennas.

In certain embodiments, system 100 can be a multiple-input multiple-output (MIMO) communication system. Further, system 100 can utilize substantially any type of duplex technique to divide communication channels (e.g., downlink 108, uplink 110, etc.) such as FDD, TDD, and the like. The channels can be provided for transmitting control data between user terminals 106 and respective base stations 104.

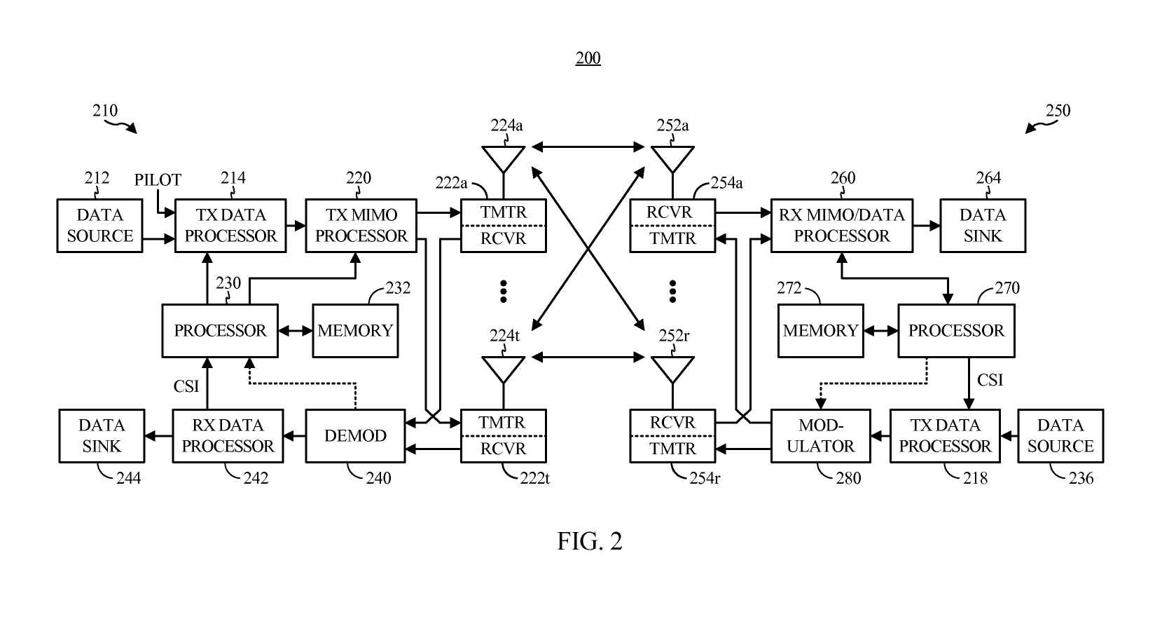

FIG. 2 illustrates an exemplary wireless network system 200 in accordance with certain embodiments set forth herein. The system 200 depicts one base station 210 and one mobile device 250 for sake of brevity. However, it is contemplated that the system 200 can include one or more base stations and/or one or more mobile devices, wherein additional base stations and/or mobile devices can be substantially similar or different from illustrated base station 210 and illustrated mobile device 250 described herein. In addition, it is contemplated that base station 210 and/or mobile device 250 can employ the systems, techniques, configurations, embodiments, aspects, and/or methods described herein to facilitate wireless communication between them.

At base station 210, traffic data for a number of data streams is provided from a data source 212 to a transmit (TX) data processor 214. In certain embodiments, each data stream can be transmitted over a respective antenna and/or over multiple antennas. TX data processor 214 formats, codes, and interleaves the traffic data stream based on a particular coding scheme selected for that data stream to provide coded data.

The coded data for each data stream can, for example, be multiplexed with pilot data using orthogonal frequency division multiplexing (OFDM) techniques. Additionally or alternatively, the pilot symbols can be frequency division multiplexed (FDM), time division multiplexed (TDM), or code division multiplexed (CDM). The pilot data is typically a known data pattern that is processed in a known manner and can be used at mobile device 250 to estimate channel response or other communication parameters and/or characteristics. The multiplexed pilot and coded data for each data stream can be modulated (e.g., symbol mapped) based on a particular modulation scheme (e.g., binary phase-shift keying (BPSK), quadrature phase-shift keying (QPSK), M-phase-shift keying (M-PSK), M-quadrature amplitude modulation (M-QAM), etc.) selected for that data stream to provide modulation symbols. The data rate, coding and modulation for each data stream can be determined by instructions performed or provided by processor 230.

The modulation symbols for the data streams can be provided to a TX MIMO processor 220, which can further process the modulation symbols (e.g., for OFDM). TX MIMO processor 220 then provides Nt modulation symbol streams to Nt transmitters (TMTR) 222a through 222t. In certain embodiments, TX MIMO processor 220 applies certain multi-antenna techniques, such spatial multiplexing, diversity coding or precoding (i.e., beamforming, with weights being applied to the modulation symbols of the data streams and to the antenna from which the symbol is being transmitted).

Each transmitter 222 receives and processes a respective modulation symbol stream to provide one or more analog signals, and further conditions (e.g., amplifies, filters, upconverts, etc.) the analog signals to provide a modulated signal suitable for transmission over the MIMO channel. Further, Nt modulated signals from transmitters 222a through 222t are transmitted from Nt antennas 224a through 224t, respectively.

At mobile device 250, the transmitted modulated signals are received by Nr antennas 252a through 252r and the received signal from each antenna 252 is provided to a respective receiver (RCVR) 254a through 254r. Each receiver 254 conditions (e.g., filters, amplifies, downconverts, etc.) a respective signal, digitizes the conditioned signal to provide samples, and further processes the samples to provide a corresponding “received” symbol stream.

A receive (RX) data processor 260 can receive and process the Nr received symbol streams from Nr receivers 254 based on a particular receiver processing technique to provide Nt “detected” symbol streams. RX data processor 260 can demodulate, deinterleave, decode, and etc., each detected symbol stream to recover the traffic data for the data stream, and provide the traffic data to a data sink 262. In certain embodiments, for mobile device 250, the processing by RX data processor 260 can be complementary to that performed by TX MIMO processor 220 and TX data processor 214 at base station 210.

A processor 270 can periodically determine which precoding matrix to utilize as discussed above. Further, processor 270 can formulate a reverse link message comprising a matrix index portion and a rank value portion. The reverse link message can comprise various types of information regarding the communication link and/or the received data stream. The reverse link message can be processed by a TX data processor 238, which also receives traffic data for a number of data streams from a data source 236, modulated by a modulator 280, conditioned by transmitters 254a through 254r, and transmitted back to base station 210.

At base station 210, the modulated signals from mobile device 250 are received by Nt antennas 224, conditioned by respective Nt receivers 222, demodulated by a demodulator 240, and processed by a RX data processor 242 to extract the reverse link message transmitted by mobile device 250, and provide the reverse link message to a data sink 244. Further, processor 230 can process the extracted message to determine which precoding matrix to use for determining the beamforming weights.

Processors 230 and 270 can direct (e.g., control, coordinate, manage, etc.) operation at base station 210 and mobile device 250, respectively. Respective processors 230 and 270 can be associated with memory 232 and 272 that store program codes and data. Processors 230 and 270 can also perform computations to derive frequency and impulse response estimates for the uplink and downlink, respectively. All “processor” functions can be migrated between and among process modules such that certain processor modules may not be present in certain embodiments, or additional processor modules not illustrated herein may be present.

Memory 232 and 272 (as with all data stores disclosed herein) can be either volatile memory or nonvolatile memory or can include both volatile and nonvolatile portions, and can be fixed, removable or include both fixed and removable portions. By way of illustration, and not limitation, nonvolatile memory can include read only memory (ROM), programmable ROM (PROM), electrically programmable ROM (EPROM), electrically erasable PROM (EEPROM), or flash memory. Volatile memory can include random access memory (RAM), which acts as external cache memory. By way of illustration and not limitation, RAM is available in many forms such as synchronous RAM (SRAM), dynamic RAM (DRAM), synchronous DRAM (SDRAM), double data rate SDRAM (DDR SDRAM), enhanced SDRAM (ESDRAM), Synchlink™ DRAM (SLDRAM), and direct Rambus™ RAM (DRRAM). Memory of the certain embodiments is intended to comprise, without being limited to, these and any other suitable types of memory.

### Exemplary CQI Channel Pre-Allocation for Base Station Handover

In seamless handover specified in the IEEE 802.16 standard, the target base station (BS) and serving BS pre-negotiate new Connection Identifiers (CIDs) to be used at the target BS once the mobile station begins to be served by the target BS. Because the CIDs are pre-allocated, it is possible for the target BS to address downlink and uplink allocations to the MS from a pre-determined time. The MS may store all the data received from the target BS until the Ranging Request/Response handshake is completed.

However, the seamless handover mechanism has two main disadvantages. First, the target base station may not know which modulation and coding scheme (MCS) to use to either send the data to the mobile station or to assign uplink allocations to the mobile station. Second, it is not clear how often the target base station should send the new assignment massages before the Ranging Request/Response handshake is completed, thereby leading to unnecessary overhead.

Certain embodiments of the present disclosure allow a target base station (BS) and a serving BS to pre-negotiate a specific location where a mobile station (MS) who is handing over from the serving BS to the target BS may start sending channel quality information (CQI) to the target BS. As soon as the target BS detects incoming CQI on this pre-negotiated channel, the target BS may select an MCS based on the received CQI information and start allocating resources for data transmission to the MS. Thus, resources may be allocated to the mobile station more efficiently because the dimensions for data (e.g., modulation and coding scheme) may be matched to channel quality.

For certain embodiments of the present disclosure, pre-negotiating the CQI information between the serving BS and the target BS may eliminate the need for the target BS to send a channel quality information channel (CQICH) allocation information element (IE) message to the MS who is handing over, which may help improve (reduce) the latency of the handover.

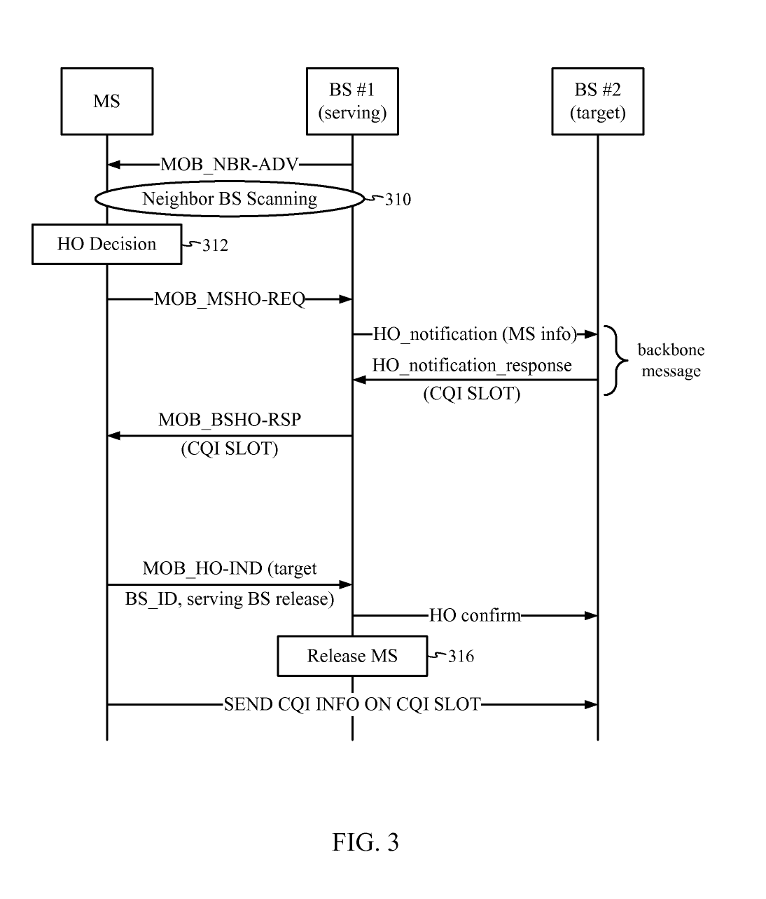

FIG. 3 illustrates example message exchange for a handover (HO) procedure based on pre-negotiated channel quality indicator information. In the illustrated example, a handover initiated by an MS is assumed, although those skilled in the art will recognize that the techniques presented herein may also be applied in the case where a BS initiates a handover by the MS.

A serving base station (BS1 in FIG. 3) may periodically broadcast the network topology information using the Mobile Neighbor Advertisement (MOB_NBR-ADV) message 302, which includes information about neighboring base stations.

For example, in one embodiment, the MOB_NBR-ADV message 302 may include information about Fast Feedback (FFB) region of neighboring base stations. Through scanning 310 of neighboring base stations, an MS may select a specific BS (i.e., a target BS) for the handover (HO) process. If the mobile station decides (at 312) to handover to a target BS (BS2 in FIG. 3), the MS may send a Mobile MS Handover Request (MOB_MSHO-REQ) message 304 to the serving BS in order to request the handover.

The MOB_MSHO-REQ message 304 may specify a set of candidate target BSs, as well as information about Carrier to Interference-plus-Noise Ratio (CINR), Received Signal Strength Indication (RSSI) and Round Trip Delay (RTD) at the mobile station side of the communication link.

Based on the MOB_MSHO-REQ message 304, the serving BS may notify the selected target BS about the HO process by sending a HO_notification message 306 that contains specific information related to an MS to the target BS. After that, the target BS may send an HO_notification_response massage 314 to the currently serving BS in order to acknowledge support for the HO process. The HO_notification 306 and HO_notification_response 314 massages may be exchanged between the serving base station and the target base station through the back bone network.

For certain embodiments of the present disclosure, the serving BS and the target BS may pre-negotiate a specific location in which the MS who is handing over, may send CQI information to the target BS. For example, the HO_notification_response message 314 sent from the target BS to the serving BS may also include a channel quality indicator (CQI) slot within the fast feedback (FFB) region in the uplink sub-frame of the target BS. The CQI slot may be used by the MS to send CQI information to the target BS. Once the HO_notification_response message 314 is received, the serving BS may send an HO_confirmation message 320 to the target BS.

Following the HO confirmation message 320, the serving BS may send a Mobile BS Handover Response (MOB_BSHO-RSP) message 308 to the MS with specific information related to the target BS. For example, in one embodiment, the specific information may include the CQI slot transmitted to the serving BS via the HO_notification_response message 314. The MS may then send a Mobile Handover Indication (MOB_HO-IND) message 318 to the currently serving BS. The MOB_HO-IND message 318 may contain the identification (ID) of the target BS and may request to release (at 316) the currently serving BS after a Resource Retain time period has been elapsed.

Once the MS releases from the serving BS, the MS may immediately start sending CQI information 322 to the target BS on the pre-allocated CQI slot in the Fast Feedback Region in the uplink sub-frame of the target BS. As a result, the target BS may select an MCS using the received CQI information and start allocating resources for data transmission to the MS. As a result, resources may be allocated more efficiently because the dimensions for data transferred from the target BS to the mobile station are matched to channel quality. Also, there is no need for the target BS to send channel quality information channel allocation (CQICH) feedback to the MS, thereby improving the latency of the handover.

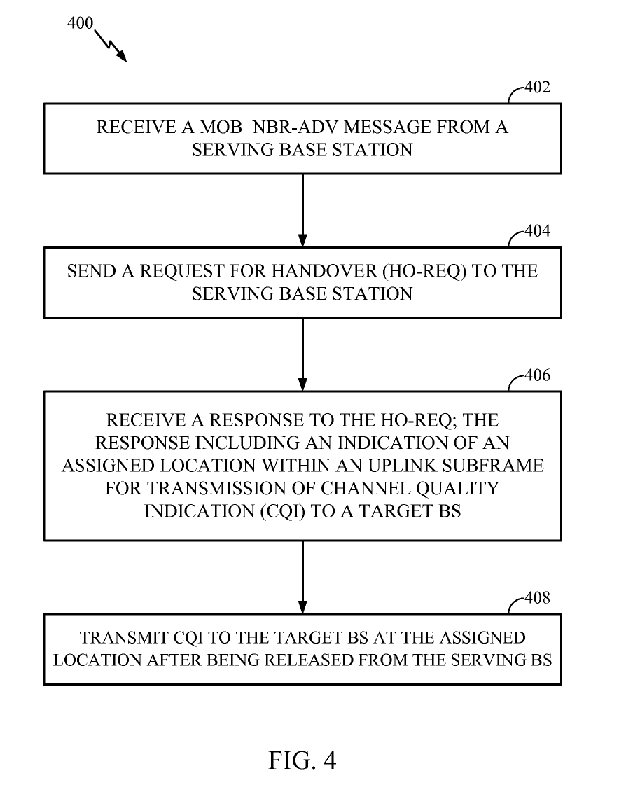

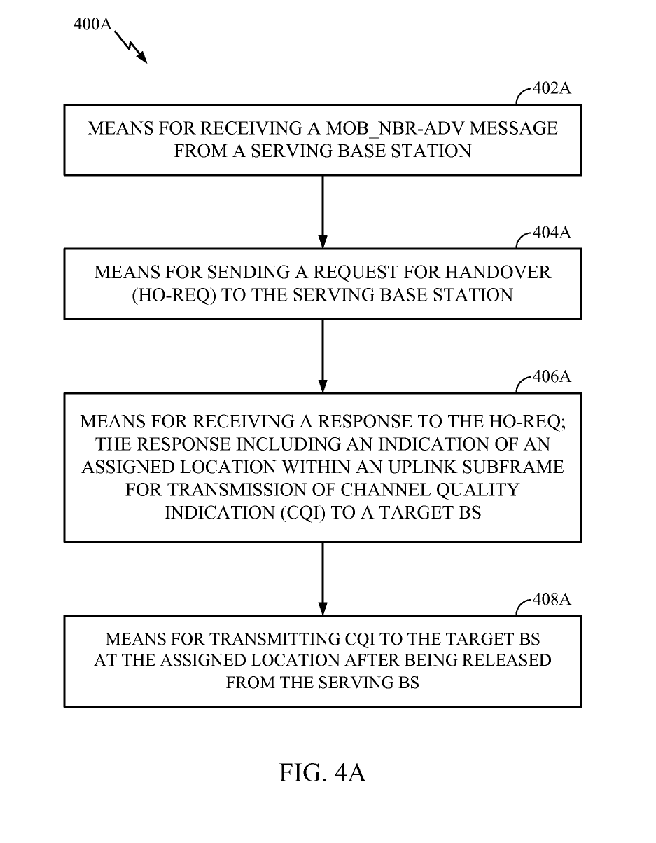

FIG. 4 illustrates example operations 400 that may be performed by a mobile station for an improved handover technique, in accordance with certain embodiments of the present disclosure.

At 402, the mobile station receives a MOB_NBR-ADV message from a serving base station. At 404, the mobile station sends a request for handover (HO-REQ) to a serving base station. At 406, the mobile station receives a response to the HO-REQ; the response including an indication of an assigned location within an uplink subframe for transmission of channel quality indication (CQI) information to the target BS. At 408, the mobile station transmits CQI to the target BS at the assigned location after (or before or simultaneously with) being released from serving BS.

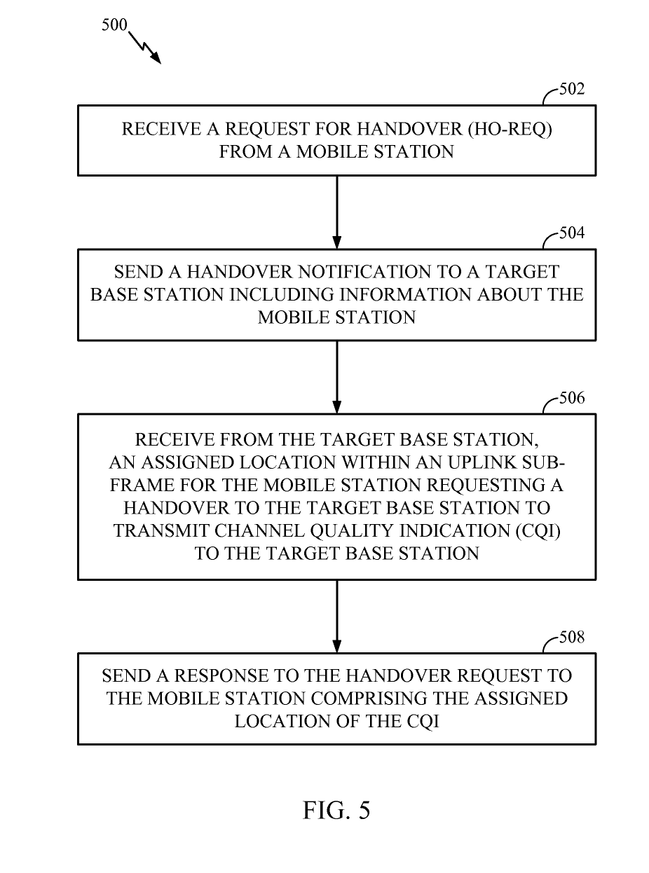

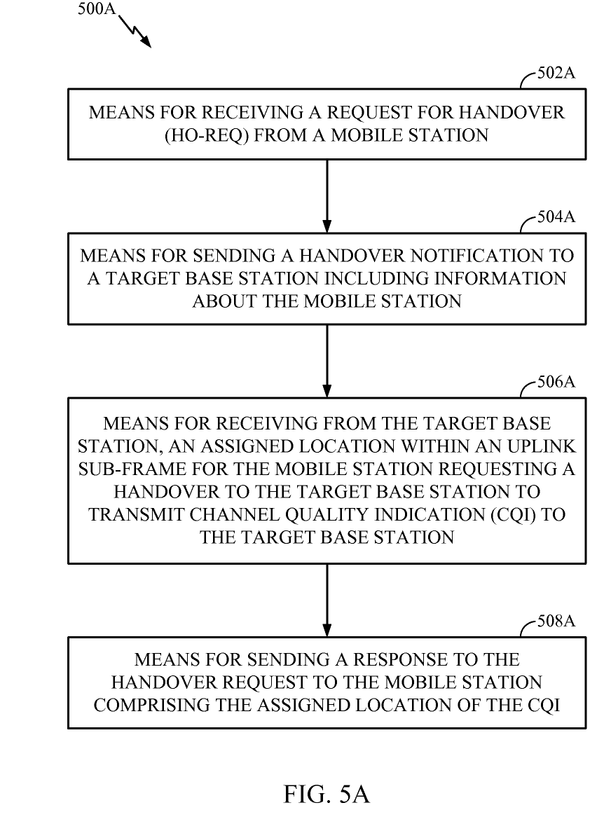

FIG. 5 illustrates example operations 500 that may be performed by a serving base station for an improved handover technique by pre-negotiating channel quality information between a serving base station and a target base station, in accordance with certain embodiments of the present disclosure.

At 502, the serving base station receives a request for handover (HO-REQ) message from a mobile station. At 504, the serving base station sends a handover notification to a target base station including information about a mobile station. At 506, the serving base station receives, from a target base station, an assigned location within an uplink sub-frame for a mobile station requesting a handover to the target base station to transmit channel quality information (CQI) to the target base station. At 508, the serving base station sends a response to the handover request to the mobile station comprising the assigned location of the CQI.

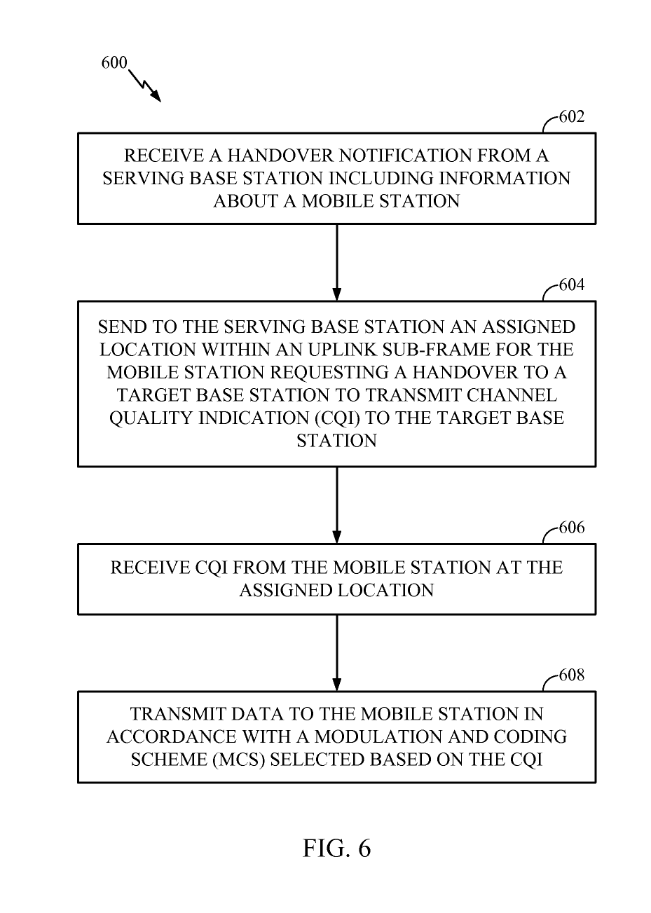

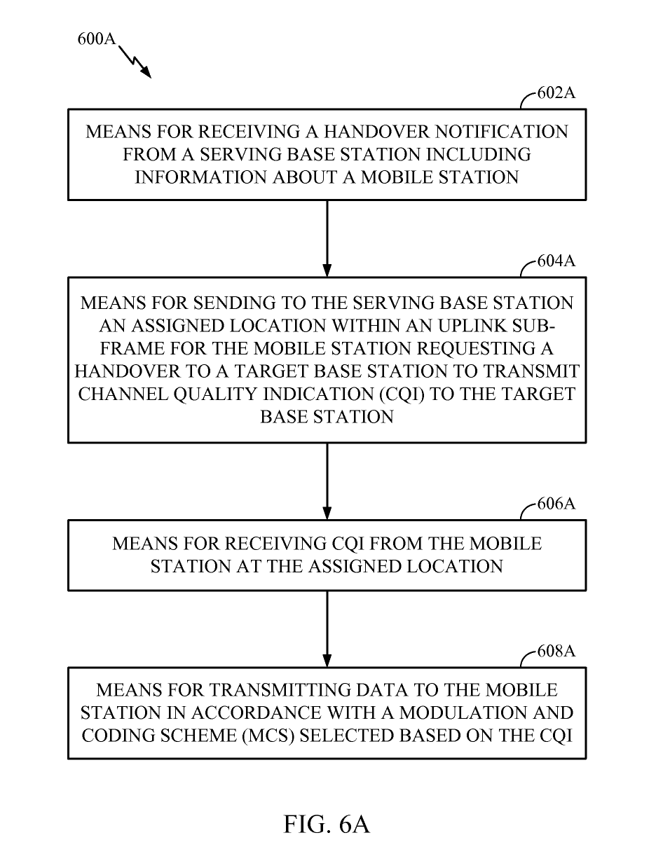

FIG. 6 illustrates example operations 600 that may be performed by a target base station for an improved handover technique by pre-negotiating channel quality information between a serving base station and a target base station, in accordance with certain embodiments of the present disclosure.

At 602, the target base station receives a handover notification from a serving base station including information about a mobile station. At 604, the target base station sends, to a serving base station, an assigned location within an uplink sub-frame for a mobile station requesting a handover to the target base station to transmit channel quality indication (CQI) information to the target base station. At 606, the target base station receives CQI from the mobile station at the assigned location. At 608, the target base station transmits data to the mobile station in accordance with a modulation and coding scheme (MCS) selected based on the CQI.

The various operations of methods described above may be performed by various hardware and/or software component(s) and/or module(s) corresponding to means-plus-function blocks illustrated in the Figures. For example, operations 400, 500 and 600 illustrated in FIGS. 4, 5 and 6 correspond to means-plus-function blocks 400A, 500A and 600A illustrated in FIGS. 4A, 5A and 6A, respectively. More generally, where there are methods illustrated in Figures having corresponding counterpart means-plus-function Figures, the operation blocks correspond to means-plus-function blocks with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the present disclosure may be embodied directly in hardware, in a software module executed by a processor, or in a combination of the two. A software module may reside in any form of storage medium that is known in the art. Some examples of storage media that may be used include random access memory (RAM), read only memory (ROM), flash memory, EPROM memory, EEPROM memory, registers, a hard disk, a removable disk, a CD-ROM and so forth. A software module may comprise a single instruction, or many instructions, and may be distributed over several different code segments, among different programs, and across multiple storage media. A storage medium may be coupled to a processor such that the processor can read information from, and write information to, the storage medium. In the alternative, the storage medium may be integral to the processor.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to embodiments of the present disclosure, other and further embodiments of the disclosure may be devised without departing from the basic scope thereof, and the scope thereof is determined by the claims that follow.

What is claimed is:

1. A method for wireless communication comprising:
sending a handover request to a serving base station for handover to a target base station;
receiving a response to the handover request, the response including an indication of an assigned location within an uplink sub-frame for transmitting channel quality information (CQI) to the target base station; and
transmitting the CQI to the target base station at the assigned location.

2. The method of claim 1, further comprising receiving data from the target base station transmitted in accordance with a modulation and coding scheme (MCS) selected based on the CQI.

3. The method of claim 1, wherein the assigned location within the uplink sub-frame for transmitting the CQI to the target base station comprises a CQI slot in a fast feedback region in the uplink sub-frame.

4. A method for wireless communication by a target base station comprising:
sending, to a serving base station, an assigned location within an uplink sub-frame for a mobile station requesting a handover to the target base station to transmit channel quality information (CQI) to the target base station;
receiving the CQI from the mobile station at the assigned location; and
transmitting data to the mobile station in accordance with a modulation and coding scheme (MCS) selected based on the CQI.

5. The method of claim 4, further comprising:
receiving a handover notification from the serving base station; and
sending the assigned location to the serving base station in response to the handover notification.

6. The method of claim 4, wherein the assigned location within the uplink sub-frame for transmitting the CQI to the target base station comprises a CQI slot in a fast feedback region in the uplink sub-frame.

7. A method for wireless communication by a serving base station comprising:
receiving, from a target base station, an assigned location within an uplink sub-frame for a mobile station requesting a handover to the target base station to transmit channel quality information (CQI) to the target base station;
sending the assigned location to the mobile station;
receiving a handover indication that the mobile station is to handover to the target base station; and
releasing the mobile station.

8. The method of claim 7, further comprising:
receiving a handover request from the mobile station; and
sending the assigned location to the mobile station in response to the handover request.

9. The method of claim 7, further comprising:
sending a handover notification to the target base station; and
receiving the assigned location from the target base station in response to the handover notification.

10. The method of claim 7, wherein the assigned location within the uplink sub-frame for transmitting the CQI to the target base station comprises a CQI slot in a fast feedback region in the uplink sub-frame.

11. An apparatus for wireless communication comprising:
logic for sending a handover request to a serving base station for handover to a target base station;
logic for receiving a response to the handover request, the response including an indication of an assigned location within an uplink sub-frame for transmitting channel quality information (CQI) to the target base station; and
logic for transmitting the CQI to the target base station at the assigned location.

12. The apparatus of claim 11, further comprising receiving data from the target base station transmitted in accordance with a modulation and coding scheme (MCS) selected based on the CQI.

13. The apparatus of claim 11, wherein the assigned location within the uplink sub-frame for transmitting the CQI to the target base station comprises a CQI slot in a fast feedback region in the uplink sub-frame.

14. An apparatus for wireless communication by a target base station comprising:
logic for sending, to a serving base station, an assigned location within an uplink sub-frame for a mobile station requesting a handover to the target base station to transmit channel quality information (CQI) to the target base station;
logic for receiving the CQI from the mobile station at the assigned location; and
logic for transmitting data to the mobile station in accordance with a modulation and coding scheme (MCS) selected based on the CQI.

15. The apparatus of claim 14, further comprising:
logic for receiving a handover notification from the serving base station; and
logic for sending the assigned location to the serving base station in response to the handover notification.

16. The apparatus of claim 14, wherein the assigned location within the uplink sub-frame for transmitting the CQI to the target base station comprises a CQI slot in a fast feedback region in the uplink sub-frame.

17. An apparatus for wireless communication by a serving base station comprising:
logic for receiving, from a target base station, an assigned location within an uplink sub-frame for a mobile station requesting a handover to the target base station to transmit channel quality information (CQI) to the target base station;
logic for sending the assigned location to the mobile station;
logic for receiving a handover indication that the mobile station is to handover to the target base station; and
logic for releasing the mobile station.

18. The apparatus of claim 17, further comprising:
logic for receiving a handover request from the mobile station; and
logic for sending the assigned location to the mobile station in response to the handover request.

19. The apparatus of claim 17, further comprising:
logic for sending a handover notification to the target base station; and
logic for receiving the assigned location from the target base station in response to the handover notification.

20. The apparatus of claim 17, wherein the assigned location within the uplink sub-frame for transmitting the CQI to the target base station comprises a CQI slot in a fast feedback region in the uplink sub-frame.

21. An apparatus for wireless communication comprising:
means for sending a handover request to a serving base station for handover to a target base station;
means for receiving a response to the handover request, the response including an indication of an assigned location within an uplink sub-frame for transmitting channel quality information (CQI) to the target base station; and
means for transmitting the CQI to the target base station at the assigned location.

22. The apparatus of claim 21, further comprising receiving data from the target base station transmitted in accordance with a modulation and coding scheme (MCS) selected based on the CQI.

23. The apparatus of claim 21, wherein the assigned location within the uplink sub-frame for transmitting the CQI to the target base station comprises a CQI slot in a fast feedback region in the uplink sub-frame.

24. An apparatus for wireless communication by a target base station comprising:
means for sending, to a serving base station, an assigned location within an uplink sub-frame for a mobile station requesting a handover to the target base station to transmit channel quality information (CQI) to the target base station;
means for receiving the CQI from the mobile station at the assigned location; and
means for transmitting data to the mobile station in accordance with a modulation and coding scheme (MCS) selected based on the CQI.

25. The apparatus of claim 24, further comprising:
means for receiving a handover notification from the serving base station; and
means for sending the assigned location to the serving base station in response to the handover notification.

26. The apparatus of claim 24, wherein the assigned location within the uplink sub-frame for transmitting the CQI to the target base station comprises a CQI slot in a fast feedback region in the uplink sub-frame.

27. An apparatus for wireless communication by a serving base station comprising:
means for receiving, from a target base station, an assigned location within an uplink sub-frame for a mobile station requesting a handover to the target base station to transmit channel quality information (CQI) to the target base station;
means for sending the assigned location to the mobile station;
means for receiving a handover indication that the mobile station is to handover to the target base station; and
means for releasing the mobile station.

28. The apparatus of claim 27, further comprising:
means for receiving a handover request from the mobile station; and
means for sending the assigned location to the mobile station in response to the handover request.

29. The apparatus of claim 27, further comprising:
means for sending a handover notification to the target base station; and
means for receiving the assigned location from the target base station in response to the handover notification.

30. The apparatus of claim 27, wherein the assigned location within the uplink sub-frame for transmitting the CQI to the target base station comprises a CQI slot in a fast feedback region in the uplink sub-frame.

31. A computer-program product for wireless communication, comprising a computer readable medium having instructions stored thereon, the instructions being executable by one or more processors and the instructions comprising:
instructions for sending a handover request to a serving base station for handover to a target base station;
instructions for receiving a response to the handover request, the response including an indication of an assigned location within an uplink sub-frame for transmitting channel quality information (CQI) to the target base station; and
instructions for transmitting the CQI to the target base station at the assigned location.

32. The computer-program product of claim 31, wherein the instructions further comprise instructions for receiving data from the target base station transmitted in accordance with a modulation and coding scheme (MCS) selected based on the CQI.

33. The computer-program product of claim 31, wherein the assigned location within the uplink sub-frame for transmitting the CQI to the target base station comprises a CQI slot in a fast feedback region in the uplink sub-frame.

34. A computer-program product for wireless communication by a target base station, comprising a computer readable medium having instructions stored thereon, the instructions being executable by one or more processors and the instructions comprising:
instructions for sending, to a serving base station, an assigned location within an uplink sub-frame for a mobile station requesting a handover to the target base station to transmit channel quality information (CQI) to the target base station;
instructions for receiving the CQI from the mobile station at the assigned location; and
instructions for transmitting data to the mobile station in accordance with a modulation and coding scheme (MCS) selected based on the CQI.

35. The computer-program product of claim 34, wherein the instructions further comprise:
instructions for receiving a handover notification from the serving base station; and
instructions for sending the assigned location to the serving base station in response to the handover notification.

36. The computer-program product of claim 34, wherein the assigned location within the uplink sub-frame for transmitting the CQI to the target base station comprises a CQI slot in a fast feedback region in the uplink sub-frame.

37. A computer-program product for wireless communication by a serving base station, comprising a computer readable medium having instructions stored thereon, the instructions being executable by one or more processors and the instructions comprising:
instructions for receiving, from a target base station, an assigned location within an uplink sub-frame for a mobile station requesting a handover to the target base station to transmit channel quality information (CQI) to the target base station;
instructions for sending the assigned location to the mobile station;
instructions for receiving a handover indication that the mobile station is to handover to the target base station; and
instructions for releasing the mobile station.

38. The computer-program product of claim 37, wherein the instructions further comprise:
instructions for receiving a handover request from the mobile station; and
instructions for sending the assigned location to the mobile station in response to the handover request.

39. The computer-program product of claim 37, wherein the instructions further comprise:
instructions for sending a handover notification to the target base station; and
instructions for receiving the assigned location from the target base station in response to the handover notification.

40. The computer-program product of claim 37, wherein the assigned location within the uplink sub-frame for transmitting the CQI to the target base station comprises a CQI slot in a fast feedback region in the uplink sub-frame.
